(19) United States
(12) Patent Application Publication
(10) Pub. No.: US 2016/0042453 A1
(43) Pub. Date: Feb. 11, 2016

(54) Electronic cannabis financial trading platform

(71) Applicants: Adam J. Schwartz, Chicago, IL (US); William Hayhurst, Chicago, IL (US)

(72) Inventors: Adam J. Schwartz, Chicago, IL (US); William Hayhurst, Chicago, IL (US)

(21) Appl. No.: 14/121,178

(22) Filed: Aug. 8, 2014

(51) Int. Cl. G06Q 40/04

(52) U.S. Cl. CPC G06Q 40/04

(57) ABSTRACT

An electronic financial market for agricultural financial instruments based on agricultural products such as cannabis financial instruments is provided that provides for price discovery. Information regarding the agricultural products, including information regarding at least one chemical compound present within the agricultural product is received. A pharmaceutical index is included in specifications for agricultural financial instruments. The index is based on the chemical compounds present within the agricultural product. The specification, including the indexing formula, is published, and the agricultural financial instrument is electronically matched.

### FIELD OF THE INVENTION

The present invention relates to electronic commodities markets.

### BACKGROUND OF THE INVENTION

The cultivation of cannabis was once a major cash crop in America. Indeed, cannabis is one of the earliest domesticated plants known, having been cultivated for over 12,000 years. Archaeologically, cannabis use dates back to the Neolithic Age in China, with hemp fiber imprints found on Yang Shao culture pottery dating from the 5th millennium B.C. The Chinese used hemp to make clothes, shoes, ropes, and an early form of paper.

Jews living in Palestine in the 2nd century were familiar with the cultivation of hemp, as witnessed by a reference in the Mishnah or “Oral Torah”. (Kil'ayim 2:5.) In late medieval Germany and Italy, hemp was employed in cooked dishes, as filling in pies and tortes or boiled in soup. In later Europe, hemp was mainly cultivated for its fibers and was used for ropes.

Spaniards brought hemp to the New World and cultivated it in Chile starting about 1545. As early as 1619, the first Virginia House of Burgesses passed an Act requiring planters in Virginia to grow hemp. The Puritans are first known to have cultivated hemp in New England in 1645.

Even U.S. Presidents grew hemp. George Washington grew hemp: In his journal of 7 Aug. 1765, Washington notes that he “began to separate the male from the female hemp . . . rather too late.” Wasserman, “This President's Day, Remember that George Washington Raised Hemp & Probably Smoked it” Huff Post Green (29 Jan. 2009) (available at http://www.huffingtonpost.com/harvey-wasserman/this-presidents-day-remem b 162088.html (accessed 29 May 0214)). Thomas Jefferson was also a hemp farmer, who invented an improved method to break the stalk by modifying a thresher. See Monticello.org, “Threshing Machine” (available at http://www.monticello.org/site/plantation-and-slavery/threshing-machine (accessed 29 May 2014)).
“To a person having a threshing machine, the addition of a hemp break will not cost more than 12. or 15. D. You know that the first mover in that machine is a horizontal horsewheel with cogs on it's upper face. On these is placed a wallower and shaft which give motion to the threshing apparatus.”
   Thomas Jefferson to George Fleming. Betts, ed. “Thomas Jefferson's Farm Book: With Commentary and Relevant Extracts from Other Writings”, at 252 (Princeton University Press, 1953. Rep. 1976, 1987, 1999.) Other presidents known to have used cannabis include James Madison (claimed it inspired him to found a nation on democratic principals), James Monroe (used until he was 73 years old), Andrew Jackson, Zachary Taylor, and Franklin Pierce.

Hemp also has more recent industrial uses. Hemp was used extensively by the United States during World War II: Uniforms, canvas, and rope were among the main textiles created from the cannabis plant. During World War II farmers were encouraged to grow cannabis to replace Manila hemp previously obtained from Japanese-controlled areas. Much of the cannabis was cultivated in Kentucky and the Midwest.

Cannabis and hemp are used in a plurality of industrial uses. Hemp is used for many varieties of products, including the manufacture of cordage of varying tensile strength, durable clothing, and nutritional products. The oil from hemp seeds oxidizes to become solid on exposure to air—similar to linseed oil—and is sometimes used in oil-based paints and in creams as a moisturizing agent. Hemp seeds have been used in bird-seed mix as well.

Other industrial purposes including paper, biodegradable plastics, construction, body products, health food, and bio-fuel. Hemp seeds can be eaten raw, ground into a meal, sprouted, made into hemp milk (akin to soy milk), prepared as tea, and used in baking. The fresh leaves can also be consumed in salads. Additional food products include cereals, frozen waffles, hemp milk ice cream, hemp tofu, and nut butters. Indeed, the amino acid profile of hemp seeds is more complete when compared to more common sources of proteins such as meat, milk, eggs and soy; hemp protein contains nutritionally significant amino acids, including the nine essential amino acids adult bodies cannot produce.

Hemp fibers are extremely strong and durable and have been shown to be used in replacement of wood for many jobs, including creating durable and breathable homes. Filtered hemp oil can be used directly to power diesel engines. Biofuels, such as biodiesel and alcohol fuel, can be made from the oils in hemp seeds and stalks, and the fermentation of the plant as a whole.

The faming of cannabis in a program of crop rotation offers benefits to farmers. Advantageous effects of growing cannabis include high weed suppression, soil loosening by the large root system, and the positive effect on soil tilth. Because the height of hemp plants and high planting density as a crop result in dense foliage, cannabis is a very effective and long used method of killing weeds by minimizing the pool of weed seeds. Using hemp this way can help farmers avoid the use of herbicides and to help gain organic certification.

Despite the long history of use of hemp industrially, the many productive uses of hemp, and the many benefits as a crop, cannabis is illegal to grow in the United States under Federal law because of its relation to marijuana. Cannabis and hemp are considered a controlled substance under the Controlled Substances Act, 21 U.S.C. 801 et. seq.

The cannabis plant produces a resin containing compounds called cannabinoids. Cannabinoids are one of a group of 21-carbon-containing terpenophenolic compounds produced by the cannabis plant as well as other sources (such as the human body). Cannabinoids are the active chemicals in cannabis that cause physiological effects throughout the body, including the central nervous system and the immune system. Cannabinoids are often referred to as phytocannabinoids when they are sourced specifically from plants.

The main psychoactive cannabinoid in cannabis is delta-9-tetrahydrocannabinol (Δ9-THC, THC). THC is one of the more than 85 cannabinoids identified in cannabis. Other cannabinoids with documented pharmacological significance are cannabinol, cannabidiol (CBD), cannabichromene, cannabigerol, tetrahydrocannabivarin, and delta-8-tetrahydrocannabinol (Δ8-THC, THC). CBD, in particular, is thought to have significant analgesic and anti-inflammatory activity without the psychoactive effect of Δ9-THC. Along with THC and CBD, there are many other cannibinoids currently being researched that are potentially relevant to the present invention.

THC mimics the action of anandamide, a neurotransmitter produced naturally in the body. THC produces the effects associated with cannabis by binding to the CB1 cannabinoid receptors in the brain.

According to Delphic analysis by British researchers in 2007, Cannabis has a lower risk factor for dependence compared to both nicotine and alcohol. See Ingraham C, “The Federal Government's Own Statistics Show That Marijuana Is Safer than Alcohol” Washington Post (31 Jul. 2014) (available at http://www.washingtonpost.com/blogs/wonkblog/wp/2014/07/31/the-federal-governments-own-statistics-show-that-marijuana-is-safer-than-alcohol/?Post+generic=%3Ftid%3Dsm_twitter_washingtonpost (accessed 31 Jul. 2014)).

Attitudes towards the use of cannabis are changing: In a 27 Jul. 2014 editorial the Editorial Board of the New York Times called for the federal government to repeal the ban on marijuana. “Repeal Prohibition, Again” (available at http://www.nytimes.com/interactive/2014/07/27/opinion/sunday/high-time-marijuana-legalization.html?_r=0 (accessed 6 Aug. 2014)).

Medical cannabis (or medical marijuana) refers to the use of cannabis and its constituent cannabinoids as medical therapy to treat disease, alleviate the symptoms of disease or alleviate the side effects of other medical therapies. The Cannabis plant has a history of medicinal use dating back thousands of years across many cultures.

Oral cannabis extract was rated as effective, and THC as probably effective, for improving multiple sclerosis patients' spasticity. Koppel B S, Brust J C, Fife T, Bronstein J, Youssof S, Gronseth G, Gloss D. “Systematic Review: Efficacy and Safety of Medical Marijuana in Selected Neurologic Disorders: Report of the Guideline Development Subcommittee of the American Academy of Neurology”. Neurology 82 (17) (April 2014). These same studies rated oral cannabis extract as effective, and THC as probably effective, in treating central pain and painful spasms. Id.

THC helps alleviate symptoms suffered both by Acquired Immune Deficiency Syndrome (AIDS), and by cancer patients undergoing chemotherapy, by increasing appetite and decreasing nausea. Haney M, Gunderson E W, Rabkin J, Hart C L, Vosburg S K, corner S D, Foltin R W. “Dronabinol and Marijuana in HIV-Positive Marijuana Smokers. Caloric Intake, Mood, and Sleep”. Journal of Acquired Immune Deficiency Syndromes 45 (5): 545-54 (2007); Abrams D I, Hilton J F, Leiser R J, Shade S B, Elbeik T A, Aweeka F T, Benowitz N L, Bredt B M, Kosel B, Aberg J A, Deeks S G, Mitchell T F, Mulligan K, Bacchetti P, McCune J M, Schambelan M. “Short-Term Effects of Cannabinoids in Patients with HIV-1 Infection: A Randomized, Placebo-Controlled Clinical Trial”. Annals of Internal Medicine 139 (4): 258-66 (2003); Grotenhermen, Franjo; Russo, Ethan, eds. “Review of Therapeutic Effects”. Cannabis and Cannabinoids: Pharmacology, Toxicology and Therapeutic Potential. New York City: Psychology Press. p. 124 (2002).

THC has also been shown to assist some glaucoma patients by reducing pressure within the eye as the cannabinoid receptors are responsible for mediated inhibition of dopamine release in the retina. Schlicker E, Timm J, Gothert M. “Cannabinoid Receptor-Mediated Inhibition of Dopamine Release in the Retina”. Naunyn-Schmiedeberg's Archives of Pharmacology 354 (6): 791-5(1996). THC decreased tremors in spinal injury patients in a 1986 double-blind, placebo-controlled crossover study. Hannigan W C, Destree R, Truong X T. “The effect of delta-9-THC on Human Spasticity”. American Society for Clinical Pharmacology and Therapeutics, Eighty-seventh Annual Meeting, Mar. 20-22, 1986 39: 198 (1986).

And in August 2009, a clinical trial by the Hadassah Medical Center in Jerusalem, Israel began investigating the effects of THC on post-traumatic stress disorders. ClinicalTrials.gov NCT00965809 (Add on Study on Δ9-THC Treatment for Posttraumatic Stress Disorders (PTSD) (THC_PTSD)).

The National Institutes of Health's National Cancer Institute reports of preclinical studies of cannabinoids use in antitumor activity. http://www.cancer.gov/cancertopics/pdq/cam/cannabis/healthprofessional/page4 (accessed 25 Jun. 2014). Studies in mice and rats have shown that cannabinoids may inhibit tumor growth by causing cell death, blocking cell growth, and blocking the development of blood vessels needed by tumors to grow. Laboratory and animal studies have shown that cannabinoids may be able to kill cancer cells while protecting normal cells. (Id.) A study in mice showed that cannabinoids may protect against inflammation of the colon and may have potential in reducing the risk of colon cancer, and possibly in its treatment. (Id.)

A laboratory study in liver cancer cells showed that Δ-9-THC damaged or killed the cancer cells. The same study in mouse models of liver cancer showed that Δ-9-THC had antitumor effects. (Id.) Δ-9-THC has been shown to cause these effects by acting on molecules that may also be found in non-small cell lung cancer cells and breast cancer cells.

A laboratory study of cannabidiol in estrogen receptor positive and estrogen receptor negative breast cancer cells showed that it caused cancer cell death while having little effect on normal breast cells. (Id.) A laboratory study of cannabidiol in human glioma cells showed that when given along with chemotherapy, cannabidiol may make chemotherapy more effective and increase cancer cell death without harming normal cells. (Id.) And a strain of cannabis high in CBD and low in THC has been effective in treating children suffering seizers. See “Medical Marijuana Refugees: ‘This was our only hope’”, CNN Health (10 Mar. 2014) (available at http://www.cnn.com/2014/03/10/health/medical-marijuana-refugees/index.html (accessed 6 Aug. 2014)).

And the laws on the use of cannabis are changing. On 28 May 2013 Governor John Hickenlooper signed two bills that made Colorado the world's first fully regulated recreational cannabis market for adults. Hickenlooper explained to the media: “Certainly, this industry will create jobs. Whether it's good for the brand of our state is still up in the air. But the voters passed Amendment 64 by a clear majority. That's why we're going to implement it as effectively as we possibly can.” See Knowles, “Colorado Becomes World's First Legal, Fully Regulated Market for Recreational Marijuana as It Anticipates Millions in Tax Revenues”, New York Daily News (28 May 2013) (available at http://www.nydailynews.comrnews/nationalkolo-1st-legal-recreational-pot-market-article-1.13 56799 (accessed 29 May 2014)). In its independent analysis, the Colorado Center on Law & Policy found that the state could expect a to see “$60 million in total combined savings and additional revenue for Colorado's budget with a potential for this number to double after 2017.” Id.

And on 8 Jul. 2014, Washington State joined Colorado in allowing the sale of recreational marijuana. Johnson, “Washington is Just Hours Away from Legalized Recreational Pot”, Huffington Post (7 Jul. 2014) (available at http://www.huffingtonpost. com/2014/07/07/legal-marijuana-sales-washington_n_{—}556292 7.html (accessed 8 July 2014)). Indeed, in addition to Colorado and Washington, at the time of filing, 25 states and the District of Columbia had enacted some form of marijuana legalization (Alaska, Arizona, California, Connecticut, Delaware, Hawaii, Illinois, Maine, Maryland, Massachusetts, Nebraska, Michigan, Minnesota, Mississippi, Montana, Nevada, New Hampshire, New Jersey, New Mexico, New York, North Carolina, Ohio, Oregon, Rhode Island, and Vermont). “Marijuana: he Great Pot Experiment” The Economist (12 Jul. 2014) (available at http://www.economist.com/news/united-states/21606851-legalising-drug-harder-it-looks-great-pot-experiment (accessed 14 Jul. 2014))—ranging from retaining marijuana as illegal but decriminalizing possession to legalizing medical use to both.

And Colorado and Washington are not the only states that see economic potential for cannabis. Perhaps due to the state's historical association with hemp production during World War II, Kentucky's Agriculture Department recently sued the federal government, seeking the release of a 250-pound shipment of hemp seeds from Italy that have been held up by customs officials. See “Kentucky Sues Federal Government Over Hemp Seeds.” Houston Chronicle (14 May 2014) (available at http://www.chron.com/news/us/ article/Ky-ag-agency-sues-for-release-of-hemp-seeds-5478630.php (accessed 23 May 2014)).

Despite this growing interest, the growth, sale, distribution, and purchase of cannabis remain subject to one of the world's most inefficient commodity marketplaces. In this sense, the cannabis marketplace resembles the grain markets of the 1800s. These markets suffered not only from supply and demand chaos, but also a lack of timely, accurate public information about the price of the commodities. Grain consumers had no way of learning what other grain consumers were paying or what the market deemed to be a fair commodity price; likewise, farmers had no way of learning what other farmers were receiving or what the market deemed to be a fair commodity price. What would thus be advantageous would be a financial market that lists cannabis financial instruments as well as provides for the publication of transaction prices (price discovery).

A financial market is a market in which people and entities can trade fungible items of value at low transaction costs and at prices that reflect supply and demand. A commodity financial market is a market that trades in primary rather than manufactured products. Soft commodities are agricultural products such as wheat, coffee, cocoa, and sugar.

Futures are one of the most common ways of investing in or hedging exposure to the price of commodities. Futures are standardized instruments traded on an organized futures exchange. A commodity future is an agreement to buy or sell a commodity sometime in the future. Futures are standardized according to delivery specifications, including the quantity, time, and location: the only variable is price which is discovered through the trading process. Commodity markets can also include physical trading and derivatives trading using spot prices, forwards, and options on futures.

Commodity financial markets provide efficient price discovery. Price discovery occurs when sellers enter the quantity and the price at which the seller is willing to sell, and buyers enter the quantity and the price at which the buyer wishes to buy. When a sell and buy order match and there is a buyer for the quantity and price offered by the seller, a trade gets generated. While futures exchanges do not set prices, the price of any given future at any given time reflects the sum total of market data and opinions driving the market.

Risk management also is a major benefit of futures markets. Hedging consists of buying or selling futures to offset the risk of changing prices. Commodity users can use futures to protect against rising cash prices; likewise, farmers can use futures to protect against falling cash prices. This risk-transfer mechanism makes futures extremely useful for controlling costs and protecting profit margins. And exchanges have well-structured settlement procedures and prudent risk management practices, which reassures an investor. The absence of counterparty risk also stands as an advantage to commodity traders. Clearing houses stand as a legal counter party between the buyer and the seller; thus the clearing house becomes buyer to every seller and seller to every buyer. Due to this, there is no need to examine the credit-worthiness of counterparty, which makes the process of trading easier.

Other benefits of commodity fmancial markets include price stabilization in times of violent price fluctuations—the commodity financial markets dampen the peaks and lifts up the valleys to reduce the amplitude of price variation; leads to integrated price structure for the commodity throughout the country; facilitates lengthy and complex production and manufacturing activities; helps balance in supply and demand position throughout the year; and encourages competition and acts as a price barometer to farmers and other trade functionaries.

The historical exclusion of onions from financial markets underscores the benefits of financial markets. Passed in 1958 after two onion traders at the Chicago Mercantile Exchange cornered 98% of the available onions in Chicago, the Onion Futures Act bans the trading of futures on onions. 7 U.S.C. §13-1. See Elfenbein, “What's the Only Commodity Banned from Futures Trading?” (23 Apr. 2012) (available at http://eideard.com/tag/onion-futures-act/ (accessed 29 May 0214)). Many economists believe that this ban has resulted in higher volatility in onions than for traded commodities. See Birger, “What Onions Teach Us about Oil Prices”, Fortune Magazine (30 Jun. 2008) (in the 2000's, onion prices were significantly more volatile than corn or oil prices) (available at http://money.cnn.com/2008/06/27/news/economy/The_onion_conundrum_Birger.fortune/?postversion=2008062713 (accessed 29 May 2014)).

Cannabis is unlike other traded commodities; the unique nature of cannabis as a commodity results in a host of issues that need to be surmounted before an economically viable financial trading platform for cannabis can exist. Among these issues are the complex, changing legal status of the commodity and the breadth of different commercial applications of the commodity as described above, as well as the complexity of delivering the commodity given the legal status of the commodity, the range of different strains of the commodity and the resultant applicability of any given strain to the different commercial applications of the commodity, the range of pharmacological content present in different strains of the commodity, the lack of uniformity of pharmacological concentration even within a strain of the commodity, etc.

### SUMMARY OF THE INVENTION

An electronic financial trading platform for agricultural financial instruments based on agricultural products such as cannabis financial instruments is provided that provides for price discovery. Information regarding the agricultural products, including information regarding at least one chemical compound present within the agricultural product is received. A pharmaceutical index is included in specifications for agricultural financial instruments. The index is based on the chemical compounds present within the agricultural product. The specification, including the indexing formula, is published, and the agricultural financial instrument is electronically matched.

### BRIEF DESCRIPTION OF THE DRAWINGS

FIG. 1 is a diagram illustrating a functioning financial market for an example cannabis agricultural market in accordance with the principals of the present invention, centered upon an electronic trading platform.

FIG. 2 is a logical diagram of example technology services layers to implement the example electronic trading platform of FIG. 1.

FIG. 3 is a schematic diagram illustrating an example infrastructure utilized within the example electronic trading platform of FIG. 1.

FIG. 4 is a schematic diagram illustrating example physical aspects of the example electronic trading platform of FIG. 1.

FIG. 5 is a schematic diagram illustrating network aspects of the example electronic trading platform of FIG. 1.

FIG. 6 is a block diagram that illustrates an example computer system upon which an embodiment of the example electronic trading platform of FIG. 1 may be implemented.

FIG. 7 is a visualization of a hypothetical THC PC Index distribution.

FIG. 8 is an example product manager screen shot of the example electronic trading platform of FIG. 1 that trading platform staff and other interested parties might use to access or create product information.

FIG. 9 is an example warehouse manager screen shot of the example electronic trading platform of FIG. 1 that trading platform staff and other interested parties might use to access and/or create trading platform approved/managed warehouse information.

FIG. 10 is an example freight and delivery manager screen shot of the example electronic trading platform of FIG. 1 that trading platform staff and other interested parties might use to access and/or create trading platform approved/managed freight and delivery vendor information.

FIG. 11 is an example trade ticket window screen shot of the example electronic trading platform of FIG. 1 demonstrating an example market participant's user interface for submitting an order to the trading platform.

### DETAILED DESCRIPTION OF AN EMBODIMENT

In accordance with the principals of the present invention, an electronic financial trading platform including, but not limited to, an electronic financial exchange is provided. An electronic financial trading platform in accordance with the principals of the present invention recognizes the changing legal status of the commodity. An electronic financial trading platform in accordance with the principals of the present invention addresses the breadth of different commercial applications of the commodity, as well as the complexity of warehousing and delivering the commodity given the legal status, transportation, and storage requirements of the commodity. An electronic financial trading platform in accordance with the principals of the present invention recognizes the range of different strains of the commodity and the resultant applicability of any given strain to the different commercial applications of the commodity. The electronic financial trading platform in accordance with the principals of the present invention addresses the range of pharmacological content present in different strains of the commodity and the lack of uniformity of pharmacological concentration even within a strain of the commodity, etc.

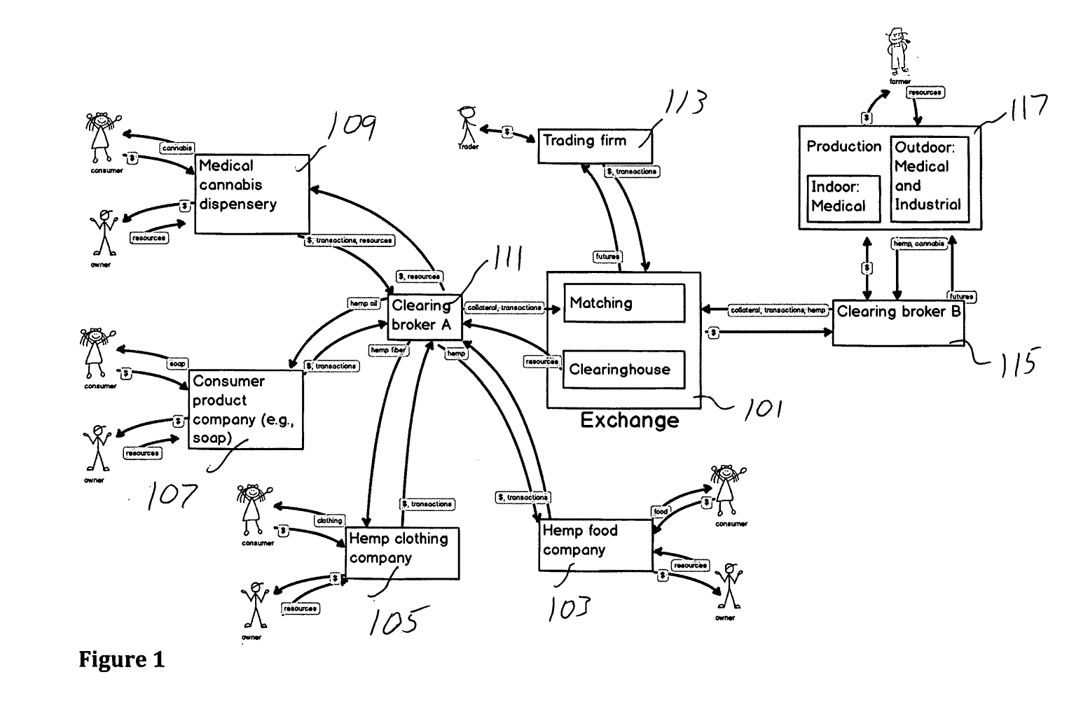

Referring now to FIG. 1, a non-limiting example centralized electronic trading platform 101 in accordance with the principals of the present invention is used to match cannabis growers with different types of cannabis market participants and consumers. Depending on the scale of their market activities, different market participants (such as food companies 103, clothing companies 105, consumer product companies 107, medical dispensaries 109, and the like) may elect to deal directly with the electronic trading platform 101, or transact via an executing or facilitating broker 111. In addition, trading firms 113 can trade on the electronic trading platform 101.

Consider, for example, executing or facilitating broker B 115, whose focus is to serve the agricultural cannabis growers 117. Executing or facilitating broker B provides liquidity to the agricultural community, crop liquidation services, access to trading platform-provided and supervised warehousing, as well as the ability for non-clearing producers to conduct arm's-length transactions. Executing or facilitating broker B uses trading platform-mandated freight services to facilitate the safe transport and delivery of cannabis to and from the trading platform warehouse as well as transaction execution on the electronic trading platform on behalf of the growers. Executing or facilitating broker A, by comparison, may cater to a broader array of market participants, providing services more focused on supplying consumers with price management and consistency for needed raw materials as well as timely and reliable means of supply/delivery (again, delivery via trading platform-mandated services). FIG. 1 also details examples of some of the specific agricultural cannabis materials different participants might wish to manage via the trading platform.

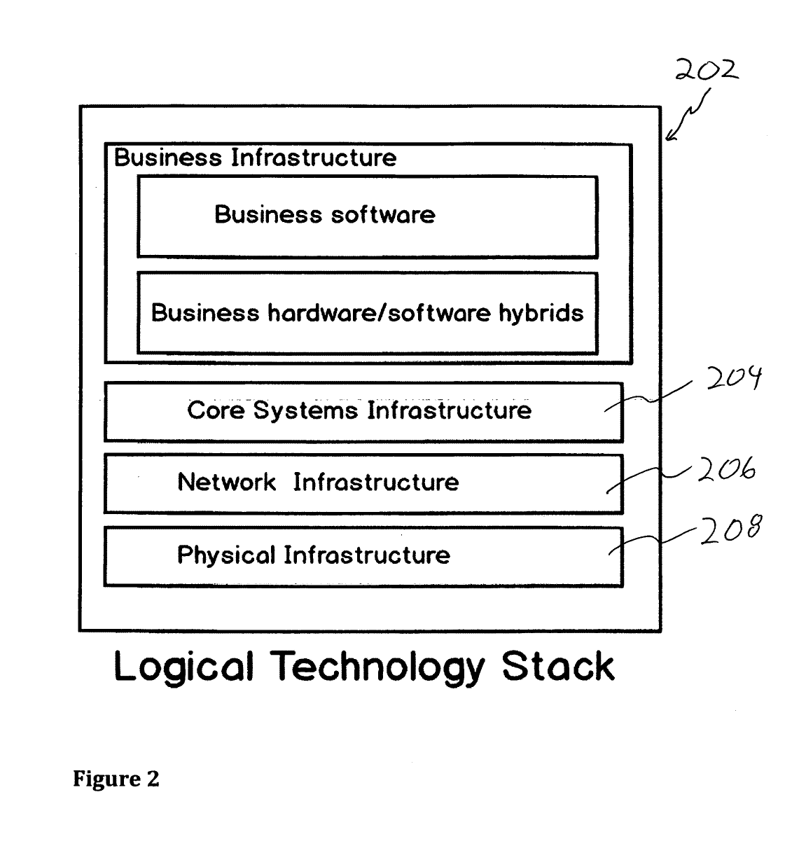

Referring now to FIG. 2, anon-limiting example of a technology infrastructure stack 202 that can be used to run a system that implements an electronic trading platform in accordance with the principals of the present invention is seen. This technology infrastructure could be implemented via both traditional and hardware-encoded software; the balance between these options may be struck based on where performance parity among participants and the need for flexibility and support dictate. As is typical of most technology ecosystems, the business infrastructure space will rest atop core infrastructure systems 204, network infrastructure 206, and physical infrastructure 208.

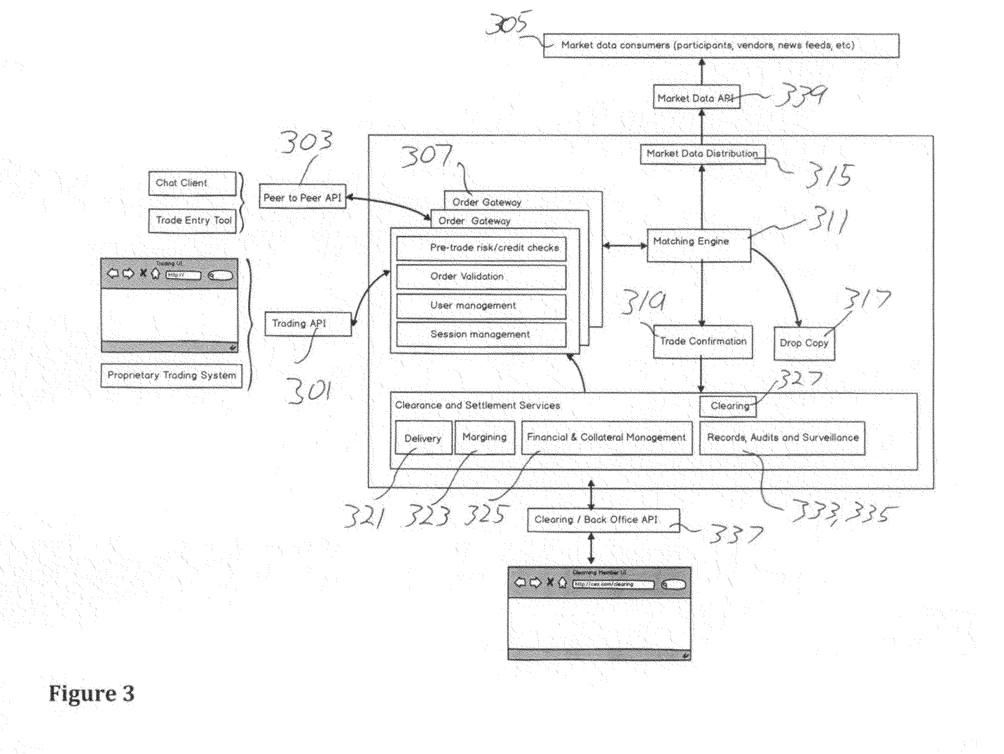

Referring now to FIG. 3, the buyers can be matched with the sellers via a computer electronic trading platform 301 or peer-to-peer messaging platform 303, depending on whether the trade is spot or futures, bilateral or cleared via the trading platform clearing house. As peer-to-peer or trades matched via the electronic central limit order book are matched, the market data memorializing the transaction is reported to the public via a public tape 305, thus facilitating price discovery for applications of the commodity. The business infrastructure software includes order gateway services 307 that route market participant orders to the proper matching engine services 311 that match market participants buy and sell orders together using a central limit order book or peer-to-peer matching and confirmation process, market data distribution services 315 that publish the state of the central limit order book as well as any off-book transactions to interested parties, trade drop copy 317 and confirmation services 319 used to coordinate with market participants and clearing members, clearing and settling services 321 implementing a combination of risk management 323, financial and collateral management 325, clearing 327, settlement 329, auditing services 333, back-office accounting software 335 that can cull a market participant's cash and futures positions and upload/download information to synchronize his/her on and off-line position. Market participants can be provided with the ability to calculate their total mark-to-market profits and losses throughout the day by calculator software tools provided by the system.

The order gateway 307 is preferably at the edge of the system holding account related information, including orders for the current day. The orders submitted by a user are typically sent through the order gateway 307 and checked for various risk management parameters, such as for example maximum size, margin requirement 323 , etc. The orders are then sent to the matching engine 311. When an order is confirmed by the matching engine 311, and is filled, partially filled, rested or cancelled, a response message is sent back to the market participant, via the order gateway. Additionally, the clearance and settlement services are notified of the trade via the trade conformation engine.

Market participants may interact with the trading platform via trading platform-provided application programming interfaces (APIs). These interfaces may be implemented either as open network protocol specifications, whereby the participant and the trading platform communicate using a shared protocol (such as the Financial Information trading platform protocol administered by the FIX Protocol Ltd., St Andrew Street, 5th Floor, London EC4A 3AE), or via an trading platform-provided linkable software library. Multiple types of API may exist depending on the client's needs; for example, an executing or facilitating broker may have an API 337 that enables interactions with the trading platform back office, delivery, margining, settlement, warehousing, records, audits, and surveillance services. For example, the records service allows users via a client computer to export account details (number, name, balance, etc.) and statements to a company providing the hosting platform. This export could be in the form of a File Transfer Program (FTP) or a Secure File Transfer Program (SFTP). The hosted trading platform environment preferably adds or updates account details and publishes statements on the web in the form of Portable Document Format (PDF) so that a user on a client computer can access their account related information from the company providing the hosted trading platform via the web. The customer back office provides a source for the SFTP to the back office import via the Internet.

Two market participants wishing to transact bilaterally may choose to report their transaction to the trading platform via a peer-to-peer API 303, upon which the terms of the transaction may be negotiated and committed. A proprietary trading system may have an API 301 that enables interactions that enable downloading of specifications, order submissions, order cancellations, production quoting, etc. Finally, market data consumers such as news feeds, data vendors, and market participants may access an API 339 that pushes via a publish-subscribe mechanism real time updates as transactions occur on the trading platform's central limit order book or off trading platform via the peer to peer trading processes.

Client computers interface with the trading platform APIs via the Internet or a direct connection. A client computer may be a desktop computer having an input device such as a mouse. In another embodiment the client computer may be a flat panel touch pad computer using a touch pen as an input device. In another embodiment, the client computer may be a server class computer without a monitor, keyboard or mouse. Of course, other types of client computers and input devices may be used with the present invention to display and make inputs on the trading screen.

In an Internet-based embodiment of the present system, the elements of the end-user interface software would typically be implemented using JavaScript, dynamic Hyper Text Markup Language (HTML) or other similar methods for providing active content to market participants using a web-browser to access the system. The underlying software, which implements functions, would typically include off-the-shelf technology where available and robust custom programs when needed. The various links and interface elements can be displayed independently.

The system can provide a visitor an introductory page or a homepage. From the homepage, a number of links can be made available to a visitor, such as links to site contact information, new user information, a bulletin board, a demonstration of the system, etc. A login function is also included to control access to certain areas and functions of the system as well as to personalize and customize a user's visit to the system. By using a login system, access to many of the features of the system can be limited to members. Furthermore, by segregating the members into different levels of membership, access to certain features and information can be further refined based on a subscriber's membership level.

Once logged-in, a user can take advantage of the electronic trading platform and the trading tools and information described in detail herein. For example, the user can choose to enter a physicals marketplace such as cannabis which is implemented, in part, through the use of the matching engine 311. Within these marketplaces, the user is able to view trading activity and place offers and bids. Alternatively, users already accustomed to transacting one or another commodity supported by the trading platform may elect to trade spot or futures “off-platform” and report the trade to the tape in order to memorialize the transaction. Market participants would be able to use the peer-to-peer instant messaging and trading mechanism supporting user-defined customizations for delivery, content, and settlement (e.g. cleared or bilateral). In some cases, participants may use the trading platform simply to document the transaction while facilitating settlement and delivery using their own resources and existing workflows. This would not reduce the value of the trading platform for the market participants, just how the market participants interact with the trading platform.

Links to other parties that support physical trading are also provided. The user can access links to financial institutions that are involved in the trading process. From these screens a user is able to inquire about and receive confirmation of credit and financial services offered through these institutions which facilitates the trading process. The user can also access links to freight providers which permits the user to work with freight forwarders. As explained further herein, many of these features are used automatically upon the conclusion of an executed trade so that financial, and other, service providers receive notification and information about a completed trade.

Because information about markets is paramount to decision making, a link to futures information is provided that allows a user to view data from one or more regional markets such as Washington, Colorado, etc. Links to other, more generic, market information, and news sources are also provided from the system. These links provide access to real-time data feeds from Thomson Reuters, Three Times Square, New York, N.Y. 10036, CNN, Turner Broadcasting System, Inc., One CNN Center, 13 North, Atlanta, Ga. 30303, Bloomberg L.P., 731 Lexington Avenue, New York, N.Y. 10022, as well as more static data such as industry-related links, and daily or monthly trading summaries generated by the system.

The system includes a futures and confirmations area and wizard. Using this wizard a user has the ability to select standard futures and other provisions agreed upon by other market participants. Utilizing such futures allows for quicker trade execution and also allows a level of confidence and predictability for market participants.

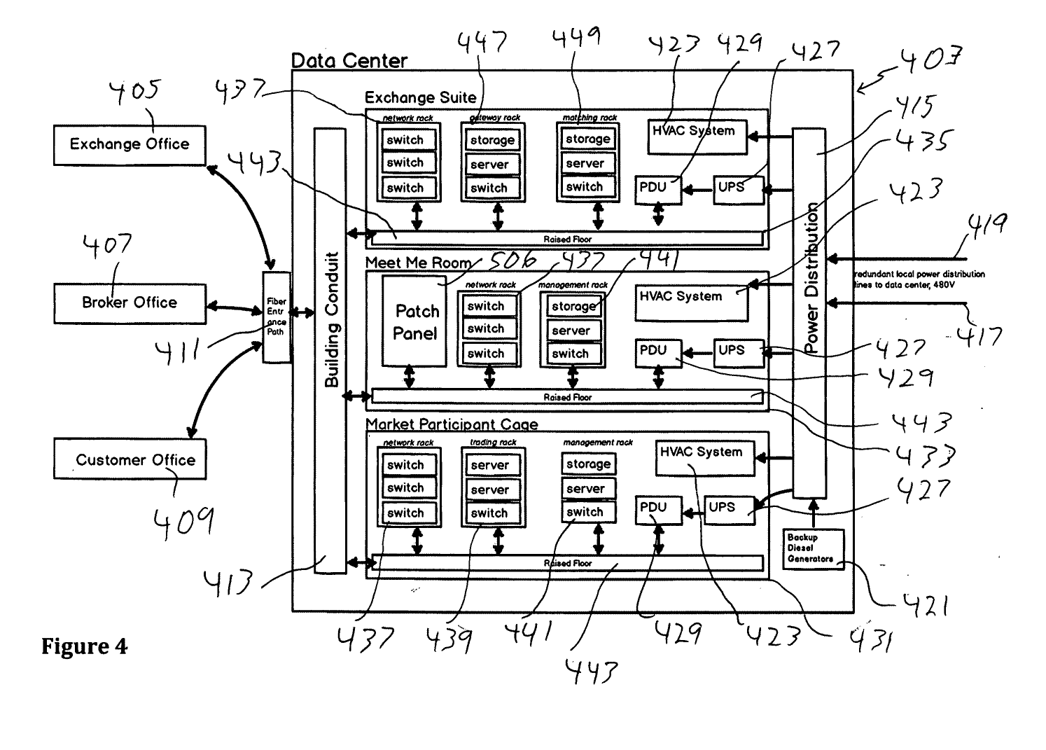

Referring now to FIG. 4, the physical infrastructure, which will be housed in redundant Tier One data centers, should include but not be limited to: electrical power, backup power, fiber entrance paths, building conduit, patch panels, power distribution units (PDUs), uninterruptable power supplies (UPS), heating, ventilation, and air conditioning (HVAC), data center racks, and different types of physical network media, such as optical fiber cable, coaxial cable, and twisted pair copper cable.

FIG. 4 is a schematic diagram illustrating example physical aspects of the example electronic trading platform of FIG. 1. A data center 403 is provided, which can interface with trading platforms 405, brokers 407 and customers 409 via for example a fiber entrance path 411. The data center 403 includes infrastructure, such as a building conduit 413, power distribution 415 preferably including redundant power distribution 417, 419 and power backup 421, heating, ventilation, and air conditioning system(s) 423. Uninterrupted power supplies (UPS) 427 and power distribution unit(s) (PDU) 429 can connect the power distribution 415 to the system components.

The data center 403 can comprise a market participant cage 431, a meet me room 433, and a trading platform data center suite 435. The market participant cage 431 can include network rack(s) 437 comprising switch(es), trading rack(s) 439 comprising server(s) and switch(es), and management rack(s) 441 comprising storage, server(s) and switch(es), all connected through suitable connectors 443.

The meet me room 433 can include network rack(s) 437 comprising switch(es) and management rack(s) 441 comprising storage, server(s) and switch(es), all connected through suitable connectors 443. In addition, a patch panel 506 detailed below is provided.

The trading platform data center suite 435 can include network rack(s) 437 comprising switch(es), gateway rack(s) 447 comprising storage, server(s) and switch(es), and matching rack(s) 449 comprising storage, server(s) and switch(es), all connected through suitable connectors 443.

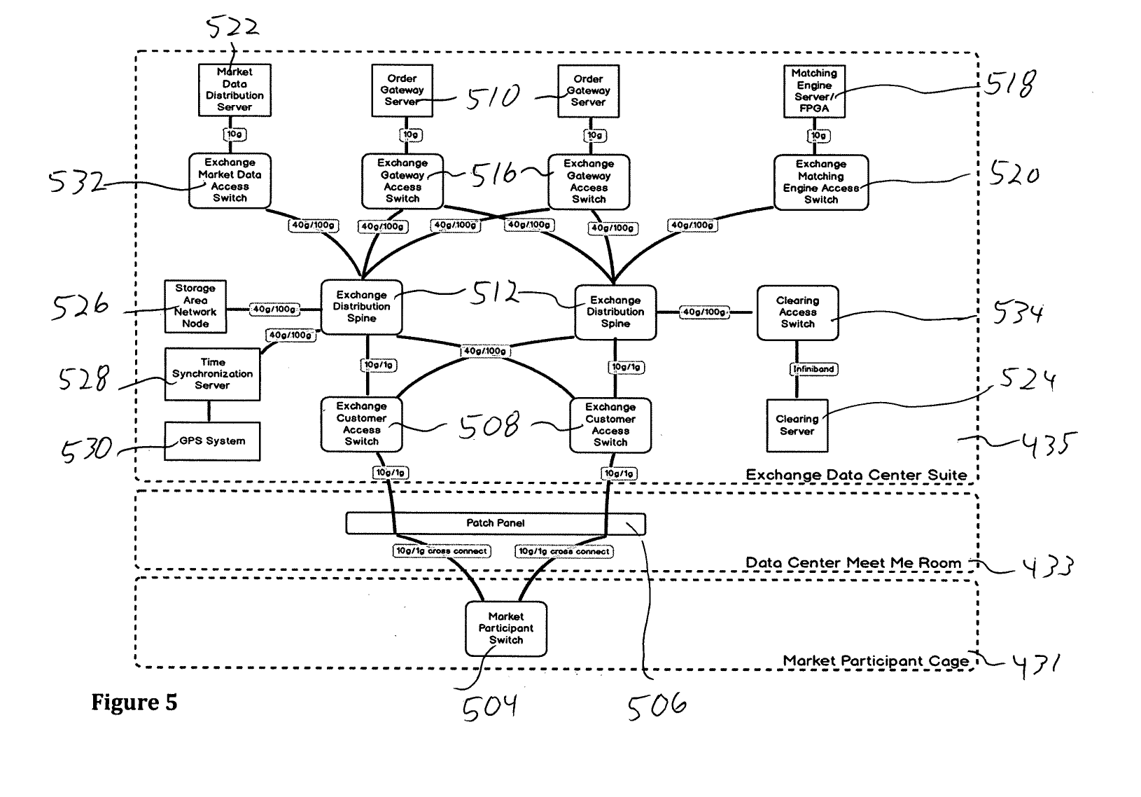

Refer now to FIG. 5, the network infrastructure, which should include but not be limited to wide area network connectivity, local area network connectivity, network patch panels, switches and routers, network cabling, time synchronization hardware, Global Positioning System (GPS) infrastructure, Internet service, locally-attached storage and storage area network hardware, and server-class computing hardware.

For the purpose of routing market participant messages to the trading platform (such as market orders or clearing messages), the market participant cage 431 connects a network switch 504, such as for example a Cisco SGE2010 48-port Gigabit switch available from Cisco Systems, Inc., 170 West Tasman Drive, San Jose, Calif. 95134, into the Meet Me Room (MMR) of the data center. The MMR serves as the telecommunications hub of the data center, providing a centralized location for users of the trading platform to physically connect and pass data to each other and the trading platform. The physical media used to “cross connect” the market participant into the MMR can be optical fiber cable, coaxial cable, twisted pair or any other networking medium. In this example, the market participant can connect into the MMR patch panel 506 using a 10GBASE-T (IEEE 802.3an-2006) Ethernet cable such as provided by Cisco. The patch panel 506 of the meet me room 433, such as for example Methode's CTI Patch Panel available from Methode Electronics, Inc., 7401 West Wilson Avenue, Chicago, Ill. 60706, is used to ease the transition from runs of cabling between the various data center residents.

From the patch panel 506, the market participant is routed into the platform data center suite 435 over physical cable, for example 10GBASE-T. This cable is terminated into a platform customer access switch 508, such as for example a Cisco Nexus 3000. The platform customer access switch 508 serves two primary functions: the first is to properly route market participant into the order gateway server 510, and the second is to convert the network traffic from 10 Gb to 100 Gb Ethernet. Traffic is converted over from 10 Gb to 100 Gb in order to provide faster data transmission and larger transmission capacity. From the access switch 508 the market participant traffic is routed into a pair of platform distribution spine switches 512, such as for example a Cisco Nexus 9000 series switch. The spine switches 512 serve the function of managing the core routing and switching functions of the electronic platform. Multiple spine switches are used to provide fault network routing resiliency and minimize latency in the system by minimizing the number of network ‘hops’ a packet can take.

From the spine switch the market participant orders are routed to the correct platform gateway access switch 516, for example a Cisco Nexus 7000 series switch. These access switches, or “leaf” switches, provide network access to the order gateway servers 510. The order gateway server 510 can be for an example an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Intel Corporation, 2200 Mission College Boulevard, Santa Clara, Calif. 95054 and Hewlett-Packard, Inc., 3000 Hanover Street, Palo Alto, Calif. 94304. Once serviced by the order gateway server 510, the order request is then routed on to the matching engine server 518 via the leaf-spine network topology and a platform matching engine access switch 520. Packet routing to the other networked hardware components in the system (market data distribution server 522, clearing servers 524, storage area network nodes 526, time synchronization server 528, GPS 530, etc.) follows a similar pattern (via platform market data access switch 532, clearing access switch 534, etc.).

Some components of the electronic platform architecture are performance sensitive, and as such the business logic in these components could be implemented using a combination of hardware and software solutions. For example, the order gateway systems used to process market participant orders could be implemented using an application integrated circuit (ASIC), a Field Programmable Gate Array (FPGA) or a Digital Signal Processor (DSP). Some implementations may be entirely hardware based. Using systems such as these helps ensure that market participants enjoy equitable performance when accessing the electronic trading platform. Other examples of performance components that could be implemented using hybrid include the market data distribution engine and matching engine services. In both cases, architecture similar to that described above could be used, with similar benefits.

The clearing and settling and administrative applications software server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply.

The hardware-software hybrid order gateway solution can run for example on an Arista 7124FX switch hosting one or more Altera Stratix V FPGA cards. The Arista 7124FX is available from Arista, located at 5443 Great America Parkway, Santa Clara, Calif. 95054. The Altera Stratix V FPGA is available from Altera Corporation, located at 101 Innovation Drive, San Jose Calif. 95134.

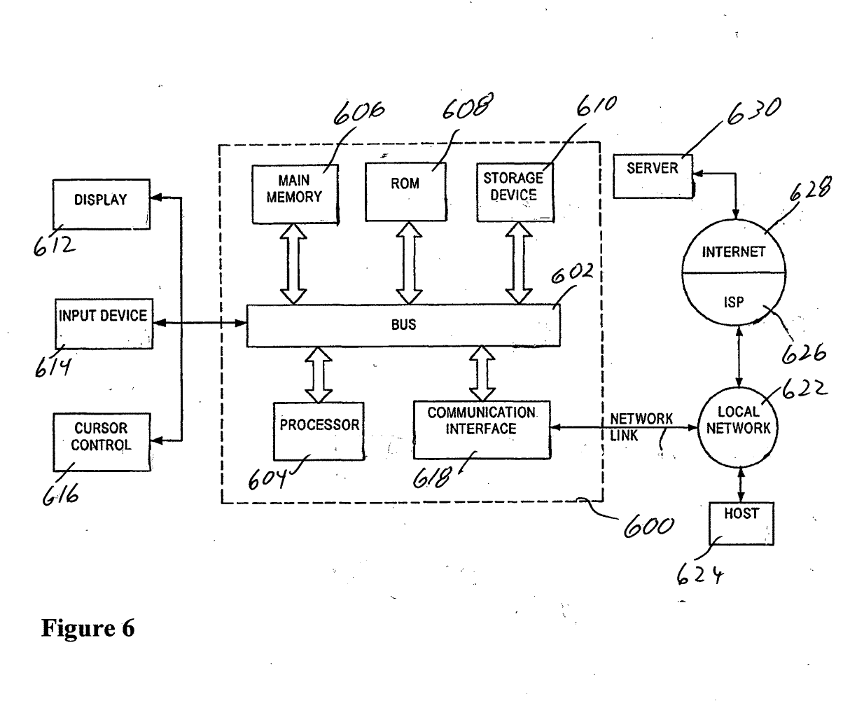

FIG. 6 is a block diagram that illustrates an example computer system 600 upon which an embodiment of the present invention may be implemented. Computer system 600 includes a bus 602 or other communication mechanism for communicating information, and a processor 604 coupled with bus 602 for processing information. Computer system 600 also includes a main memory 606, such as a Random Access Memory (RAM) or other dynamic storage device, coupled to bus 602 for storing information and instructions to be executed by processor 604. Main memory 606 also may be used for storing temporary variables or other intermediate information during execution of instructions to be executed by processor 606. Computer system 600 further includes a Read Only Memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612 for displaying information to a computer user. An input device 614, including alphanumeric and other keys, is coupled to bus 602 for communicating information and command selections to processor 604.

According to one embodiment, the present invention is implemented by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media include, for example, optical or magnetic disks, such as storage device 610. Volatile media include dynamic memory, such as main memory 606. Transmission media include coaxial cables, copper wire and fiber optics, including the wires that comprise bus 602. Transmission media can also take the form of acoustic or light waves, such as those generated during Radio Frequency (RF) and InfraRed (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a Random Access Memory (RAM), a Programmable Read Only Memory (PROM), an Erasable Programmable Read Only Memory (EPROM), a Flash Erasable Programmable Read Only Memory (FEPROM), any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be borne on a magnetic disk of a remote computer. The remote computer can load the instructions into its dynamic memory and send the instructions over a wide area network such as the Internet. A detector coupled to bus 602 can receive the data carried in the signal and place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. Wireless links may also be implemented. In any such implementation, communication interface sends and receives electrical, electromagnetic or optical signals that carry digital data streams representing various types of information.

The core software infrastructure includes an operating system such as for example Redhat Linux Enterprise AS Operating System available from Red Hat, Inc., 1801 Varsity Drive, Raleigh, N.C., core management software such as Domain Name Service (DNS), and core monitoring software such as Simple Network Management Protocol (SNMP) handlers, and database software used to persistent data to a storage solution To provide security, conventional methods and hardware are selected and implemented such as encryption of data, firewall systems, and other protection measures.

Servers for use with the present invention typically include a user handler. The user handler typically deals with the connections established by the end-users with the front-end, typically via the API. Access to the system by an end-user is preferably achieved through this the front-end. The user handler preferably maintains a secure connection with a client via Secure Socket Layer (SSL) encryption over a wide area network such as an Internet HyperText Transfer Protocol Secure (HTTPS) connection or a direct HTTPS connection. This enables authentication of the user of client and the permissions that the user of client has been assigned. Other means of maintaining a secure connection and authenticating users and permission may be implemented as would be appreciated by those of ordinary skill in the art.

Electronically traded cannabis futures or spots will be sized in a standard measurement that reflects the industry to which the future or spot relates. For example, a food-grade whole hemp seed futures specification can be sized in tons while a food-grade hemp oil future specification can be sized in liters. Where applicable, the cannabis financial instrument will identify a specific cannabis species such as for example for a food-grade whole hemp seed futures specification sativa sp. A pharmaceutical content index (“PC Index”) will be utilized to specify the availability of different pharmaceutically relevant compounds within the agricultural product described herein. A PC Index in accordance with the principals of the present invention enables market participants to assign premium valuations to agricultural futures based on the market demand for the compounds specified within that future's PC Index. Additional measures, such as for example fiber content, chemical pesticide content, microbial content, water content, and the like can be utilized depending on the underlying.

Based on the current state of research, THC is a generally accepted barometer of the expected psychoactive effects of consumption: the higher the THC content, the higher the pharmacological effect. CBN is known as a degradation product of THC: as the underlying product sits on the shelf, depending on storage conditions and the plant itself, the THC will degrade into CBN, which has a much reduced psychoactive effect. Also based on the current state of research CBD, not to be confused with CBN, may turn out to be the most pharmaceutically relevant of the over 85 active cannabinoids and as such is believed likely to be a significant driver of how market participants view the future agricultural product described herein. As research continues to further understand the pharmacological effect of additional cannabinoids, such cannabinoids may also drive how market participants view the future agricultural product described herein. Additionally, as research continues to further understand the pharmacological effect of additional agricultural products and use becomes beneficial and accepted, the principals of the present invention could be applied to such agricultural products. See, for example, Tagliazucchi E, Carhart-Harris R, Leech R, Nutt D, Chialvo D R. “Enhanced Repertoire of Brain Dynamical States”, Human Brain Mapping 00:00-00 (2 Jul. 2014) (available at http://onlinelibrary.wiley.com/enhanced/doi/10.1002/hbm.22562/ (accessed 25 Jul. 2014).

An example of a PC Index referred to herein as the THC PC Index is based the ratio of THC, CBD, and CBN. An example THC PC Index can be defined as the ratio of:

$$\frac{( \% THC - \% Cannabidiol ( CBD ) )}{MAX ( 1 , \% Cannabinol ( CBN ) ) .}$$

The THC PC Index allows market participants for THC-rich cannabis to price to cannabis futures based on the demand for THC. Here, CBD is used to reduce the THC premium, as CBD has been demonstrated to offset THC's psychoactive effects. CBN is used as a further reducing factor in that the increasing presence of CBN is an indicator of both the reduction in THC availability and reduced storage potential.

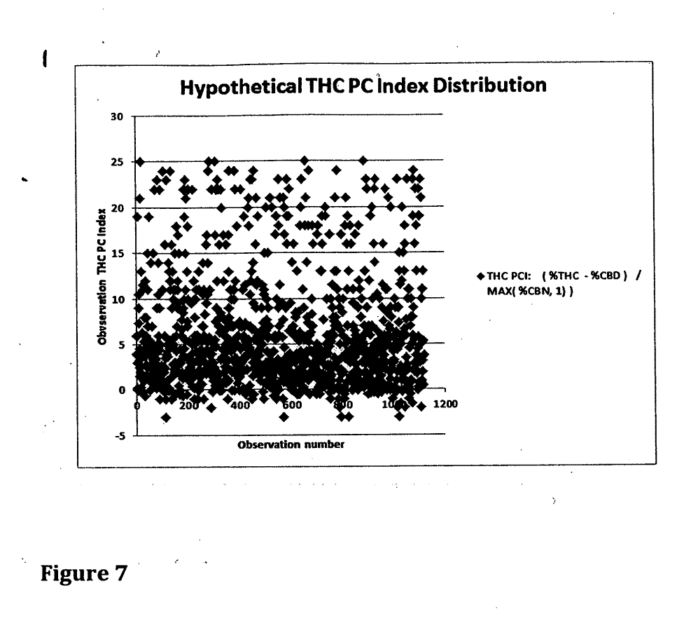

Referring to FIG. 7, a chart showing a hypothetical distribution of THC PC Index results based on a randomized generation of input values bounded hi/lo using publicly available benchmarks for cannabinoid presence in medical cannabis. The x axis is the observation number (count) of instances of a randomly-generated THC PC Index. The Y axis is the observed THC PC Index for that data point on the distribution. What emerges from the bounded randomized study is a distribution of THC PC Indices not so different than that observed in the present market for medical cannabis. High-THC, low-CBD cannabis is scarce, and seldom available at uniform ratios; hence a higher price is often applied in today's dispensary markets for such product.

An alternative PC Index, for a different primary cannabinoid, would be a CBD PC Index based on the ratio of CBD and THC. An example CBD PC Index can be defined as the ratio of:

$$\frac{( \% CBD - \% THC )}{MAX ( 1 , \% CBN ) .}$$

The CBD PC Index could be used right away to qualify cannabis futures in which CBD is identified as the primary target drug.

Because the cannabis plant contains over 85 cannabinoids and ongoing research is expected to uncover additional pharmaceutically-relevant compounds relevant to the cannabis futures described herein, the potential for extending the PC Index to cover many future novel compounds is great. Furthermore, the potential exists for the PC Index to be extended beyond cannabis, and is applicable to many other agriculturally-sourced pharmaceutical compounds.

Because different grades of cannabis have different growing seasons, different cannabis futures will have different, matched delivery months. Final settlement can be elected upon the initial transaction to be physical or financial, for example in U.S. dollars. Delivery can be made free-on-board (FOB) via authorized warehouse facilities where cannabis has been approved for exchange, made in accordance with applicable Federal, State and local laws and regulations. Market participants also may use trading platform-mandated/supervised services incorporate unique delivery, storage, and freight logistics into their futures (and spot) on transaction origination, allowing participants to adapt over time along with the domestic cannabis market without needing to fundamentally or technologically change their mechanisms for transacting. Delivery flexibility as a feature is desirable in order to enable efficient price discovery for the commodity per unique regulatory geography and to reduce the need for market participants to devote resources to technology and workflow instead of their core enterprise.

The following are non-limiting examples for cannabis futures specification:

### EXAMPLES

The following is a non-limiting example for a food-grade whole hemp seed futures specification:

An example size for a food-grade whole hemp seed futures specification can be one (1) ton (2,000 lbs) electronically traded during market hours, priced at cents U.S. Dollar per lb. with a tick size of one cent per lb. ($20.00 per tick). For the example food-grade whole hemp seed futures specification, the deliverable grade can be designated as a sativa sp. only, with a THC PC Index≦0, a THC content<5 ppm using a certified lab for Ultra (or High) Performance Liquid Chromatography (UPLC). The rationale for having both a THC PC index and a maximum THC content allowable in the specification is that food-grade cannabis requires close to zero THC be present, but it may ultimately prove meaningful to indicate the presence of CBD and CBN regardless in food-grade cannabis. Also relevant in the example food-grade whole hemp seed futures specification, chemical pesticide and microbial content must meet or exceed U.S. Food and Drug administration (FDA) standards for human consumption.

mom Delivery months can be designated as January, February, March, April, May, June, July, August, September, October, November, and December, with no price limits on the current or later futures. The daily settlement can be determined as the volume-weighted average price (VWAP) during the last ten (10) minutes of trading during regular trading days. In the event there is insufficient activity to make the aforementioned calculations, earlier data or other available market information may be utilized to determine an appropriate settlement price.

Open futures are marked-to-market daily. Final settlement is physical with the option to settle financially, for example in U.S. dollars. The final settlement prices of the expiring food-grade whole hemp seed futures can be settled on the day of expiration at that day's VWAP. In the event there is insufficient activity to make the aforementioned calculations, earlier data or other available market information may be utilized to determine an appropriate settlement price.

Delivery can be made free-on-board (FOB) via authorized warehouse facilities where food-grade hemp has been approved for trading platform. Delivery will be made in accordance with applicable Federal, State and local laws and regulations. At buyer's option, delivery shall be made for example by the following methods: by truck/rail; or if the seller agrees to such transfer and if the facility used by the seller allows for such transfer without physical movement of product, by in-warehouse transfer of title to the buyer (ongoing storage costs will be transferred). Delivery location and logistics may be specified upon entry into the transaction, whether via the central limit order book (CLOB) or a request for quote (RFQ) process.

The last trade date can be the business day prior to the 15^{th} calendar day of the future month. The last delivery date can be the second business day following the last trading day of the delivery month. An example product ticker symbol could be “WS”.

The following is a non-limiting example for an industrial hemp whole plant future specification:

An example size for an industrial hemp whole plant future specification can be five (5) tons (10,000 lbs) electronically traded during market hours, priced at cents U.S. Dollar per lb. with a tick size of one cent per lb. ($100.00 per tick). For the example industrial hemp whole plant future specification, the deliverable grade can be designated as a sativa sp. only, with a ≧30% fiber content, a THC PC Index≦0, and a THC content ≦0.03%. In the example industrial hemp whole plant future specification, the water content (as per a Karl-Fisher or similar analysis)<10%; and microbial content at or below minimum permitted by the lowest among the states in which delivery is permitted at the time of settlement.

Delivery months can be designated as April, May, June, July, August, September, October, and November, with no price limits on the current or later futures. Delivery months, at least for so long as this specification pertains to U.S.-sourced domestic cannabis, only are scheduled for months in which the northern hemisphere's outdoor growing season would foreseeably result in deliverable yields. The daily settlement can be determined as the VWAP during the last ten (10) minutes of trading during regular trading days. In the event there is insufficient activity to make the aforementioned calculations, earlier data or other available market information may be utilized to determine an appropriate settlement price.

Open futures are marked-to-market daily. Final settlement is physical with the option to settle in financially, for example in U.S. dollars. The final settlement prices of the expiring food-grade whole hemp seed futures can be settled on the day of expiration at that day's VWAP. In the event there is insufficient activity to make the aforementioned calculations, earlier data or other available market information may be utilized to determine an appropriate settlement price.

Delivery can be made FOB via authorized warehouse facilities where industrial hemp has been approved for trading platform. Delivery will be made in accordance with applicable Federal, State and local laws and regulations. At buyer's option, delivery shall be made for example by the following methods: by truck/rail; or if the seller agrees to such transfer and if the facility used by the seller allows for such transfer without physical movement of product, by in-warehouse transfer of title to the buyer (ongoing storage costs will be transferred). Delivery location and logistics may be specified upon entry into the transaction, whether via the CLOB) or a RFQ process.

The last trade date can be the business day prior to the 15^{th} calendar day of the future month. The last delivery date can be the second business day following the last trading day of the delivery month. An example product ticker symbol could be “WP”.

The following is a non-limiting example for a food-grade hemp oil future specification:

An example size for a food-grade hemp oil future specification can be 10,000 liters (L) electronically traded during market hours, priced at cents U.S. Dollar per L with a tick size of one cent per L ($100.00 per tick). For the example industrial hemp whole plant future specification, the deliverable grade can be designated as a sativa sp. only, a THC PC Index≦0, and a THC content≦5 ppm. In the example industrial hemp whole plant future specification, the water content (as per a Karl-Fisher or similar analysis)<10%; and microbial content at or below minimum permitted by the lowest among the states in which delivery is permitted at the time of settlement. In the example food-grade hemp oil future specification, chemical pesticide and microbial content meet or exceed FDA standards for human consumption and conform to specifications for U.S. Harmonized Tariff Schedule import/export code of 1515.90.8010. Purity must meet/exceed F.D.A. standard for food-grade hemp oil.

Delivery months can be designated as January, February, March, April, May, June, July, August, September, October, November, and December, with no price limits on the current or later futures. The daily settlement can be determined as the VWAP during the last ten (10) minutes of trading during each regular trading day. In the event there is insufficient activity to make the aforementioned calculations, earlier data or other available market information may be utilized to determine an appropriate settlement price.

Open futures are marked-to-market daily. Final settlement is physical with the option to settle financially, for example in U.S. dollars. The fmal settlement prices of the expiring food-grade hemp oil futures can be settled on the day of expiration at that day's VWAP. In the event there is insufficient activity to make the aforementioned calculations, earlier data or other available market information may be utilized to determine an appropriate settlement price.

Delivery can be made FOB via authorized warehouse facilities where food-grade hemp oil has been approved for trading platform. Delivery will be made in accordance with applicable Federal, State and local laws and regulations. At buyer's option, delivery shall be made for example by the following methods: by truck/rail; or if the seller agrees to such transfer and if the facility used by the seller allows for such transfer without physical movement of product, by in-warehouse transfer of title to the buyer (ongoing storage costs will be transferred). Delivery location and logistics may be specified upon entry into the transaction, whether via the CLOB or a RFQ process.

The last trade date can be the business day prior to the 15^{th} calendar day of the future month. The last delivery date can be the second business day following the last trading day of the delivery month. An example product ticker symbol could be “CO”.

The following is a non-limiting example for a medical cannabis future specification:

An example size for a medical cannabis future specification can be 2 Kg (2,000 grams) electronically traded during market hours, priced at cents U.S. Dollar per gram with a tick size of one cent per gram ($20.00 per tick). As opposed to the THC PC Index being below a threshold value, the THC PC Index for the example medical cannabis future specification is used as a grading mechanism for the pharmaceutical content of the product. In the example medical cannabis future specification, chemical pesticide and microbial content meet or exceed FDA standards for human consumption.

Delivery months can be designated as January, February, March, April, May, June, July, August, September, October, November, and December, with no price limits on the current or later futures. The daily settlement can be determined as the VWAP during the last ten (10) minutes of trading during regular trading days. In the event there is insufficient activity to make the aforementioned calculations, earlier data or other available market information may be utilized to determine an appropriate settlement price.

Open futures are marked-to-market daily. Final settlement is physical with the option to settle financially, for example in U.S. dollars. The final settlement prices of the expiring medical cannabis futures can be settled on the day of expiration at that day's VWAP. In the event there is insufficient activity to make the aforementioned calculations, earlier data or other available market information may be utilized to determine an appropriate settlement price.

Delivery can be made FOB via authorized warehouse facilities where medical cannabis has been approved for trading platform. Delivery will be made in accordance with applicable Federal, State and local laws and regulations. At buyer's option, delivery shall be made for example by the following methods: by truck/rail; or if the seller agrees to such transfer and if the facility used by the seller allows for such transfer without physical movement of product, by in-warehouse transfer of title to the buyer (ongoing storage costs will be transferred). Delivery location and logistics may be specified upon entry into the transaction, whether via the CLOB or a RFQ process.

The last trade date can be the business day prior to the 15^{th} calendar day of the future month. The last delivery date can be the second business day following the last trading day of the delivery month. An example product ticker symbol could be “MC”.

The preceding were non-limiting examples for cannabis futures specifications.

Referring now to FIG. 8, an example product manager screen shot 810 of the example electronic trading platform of FIG. 1 is seen. The product manager screen displays the financial instrument names in for example a column 812. In, for example, a row alongside the financial instrument name 812, the financial instrument symbol (e.g., in the preceding non-limiting examples: ‘MC’, ‘CD’, ‘WP’, ‘WS’) 814 and a margin symbol (e.g., ‘MX’, ‘CX’, ‘WX’, ‘WX’) 816 can be displayed. Again, for example in a row alongside the financial instrument name, a financial instrument product class 818, the traded in currency 820, the deliverable quantity 822, the tick value 824, the minimum price fluctuation 826, the trading platform fees 828, and the clearing fee 830 can be displayed. The product manager screen 810 can include tabs that can be selected to display the screens of different types of financial instrument products, such as, for example, futures 832, spot 834, and options 836. Search windows such as, for example, searches for instrument name 838, PC Index type searches 840, and PC Index value searches 842, can be provided.

The index based on the at least one chemical compound present within the underlying agricultural product of the present invention 845 and an indexing constraint 846 can further be displayed, again for example in a row alongside the financial instrument name 812. The indexing constraint data qualifies the extent to which the PC Index applied to that product is limited to some minimum or maximum value. The trading platform staff might use this product manager screen 810 to look up and manage the reference data associated with financial instrument listed on the trading platform, including initiation of new financial instruments, modification of existing financial instruments, and similar management functions. A similar screen might also be made available to trading platform trading participants and other interested parties that may wish to confirm details and availability of certain instruments.

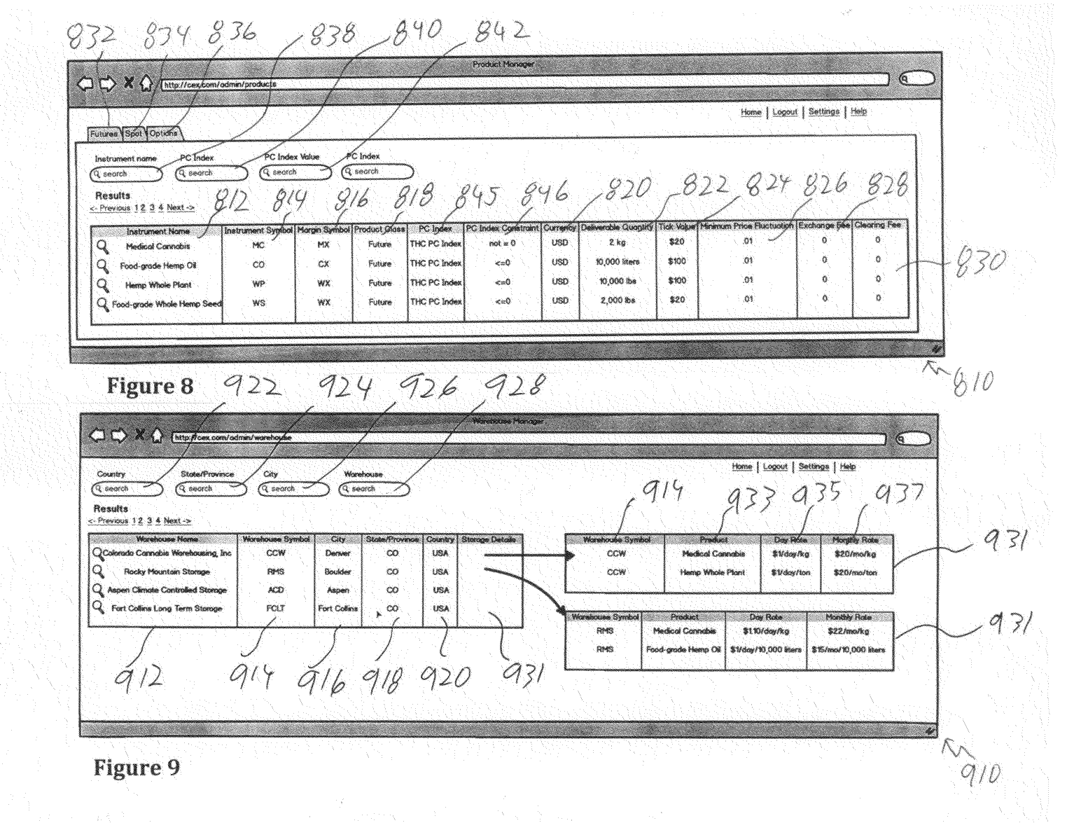

Referring now to FIG. 9, an example warehouse manager screen 910 of the example electronic trading platform of FIG. 1 is seen. The warehouse management screen 910 might contain data curated by trading platform staff, and the relevant reference data then made available to interested parties wishing to verify localities to which storage and delivery sites are convenient. The warehouse manager screen 910 can display the name of the storage warehouse 912 in, for example, a column. In, for example, a row alongside the storage warehouse name 912, a warehouse symbol 914, and the warehouse location, including city 916, state 918, and country 920 can be displayed. Search windows such as, for example, searches for warehouse location by country 922, state/providence 924, and city 926, or a warehouse specific search 928, can be provided.

In, for example, pop-up window(s), the warehouse manager screen 910 can provide storage detail 931 per warehouse facility. The storage detail 931 can confirm the warehouse symbol 914 and can include the product detail 933 and storage rate, including day rate 935 and month rate 937. This reference data will ultimately lead to users' ability to select freight vendors as well as estimate storage and other logistical expenses they must incorporate into their pricing methods for effecting economic transactions on the trading platform.

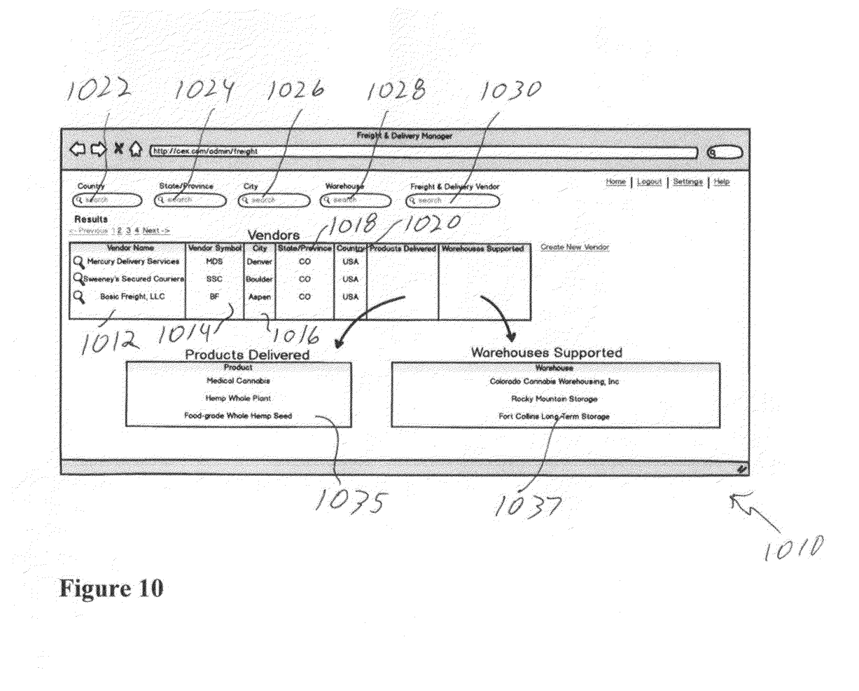

Referring now to FIG. 10, an example freight and delivery manager screen 1010 of the example electronic trading platform of FIG. 1 is seen. The freight and delivery management screen 1010 might contain data curated by trading platform staff, and the relevant reference data then made available to interested parties wishing to verify freight and delivery logistics. The freight and delivery manager screen 1010 displays the name of a vendor 1012 in, for example, a column. In, for example, a row alongside the vendor name 1012, a vendor symbol 1014 and the vendor location, including city 1016, state 1018, and country 1020, can be displayed. Search windows such as, for example, searches for vendor by country 1022, state/providence 1024, and city 1026, or a warehouse 1028 or vendor specific search 1030, can be provided

In, for example, a pop-up window, the freight and delivery manager screen 1010 can provide product delivered 1035 and a warehouse supported 1037 details. This reference data will ultimately lead to users selecting freight vendors with whom to negotiate terms as well as other logistical expenses they must incorporate into their pricing methods for effecting economic transactions on the trading platform.

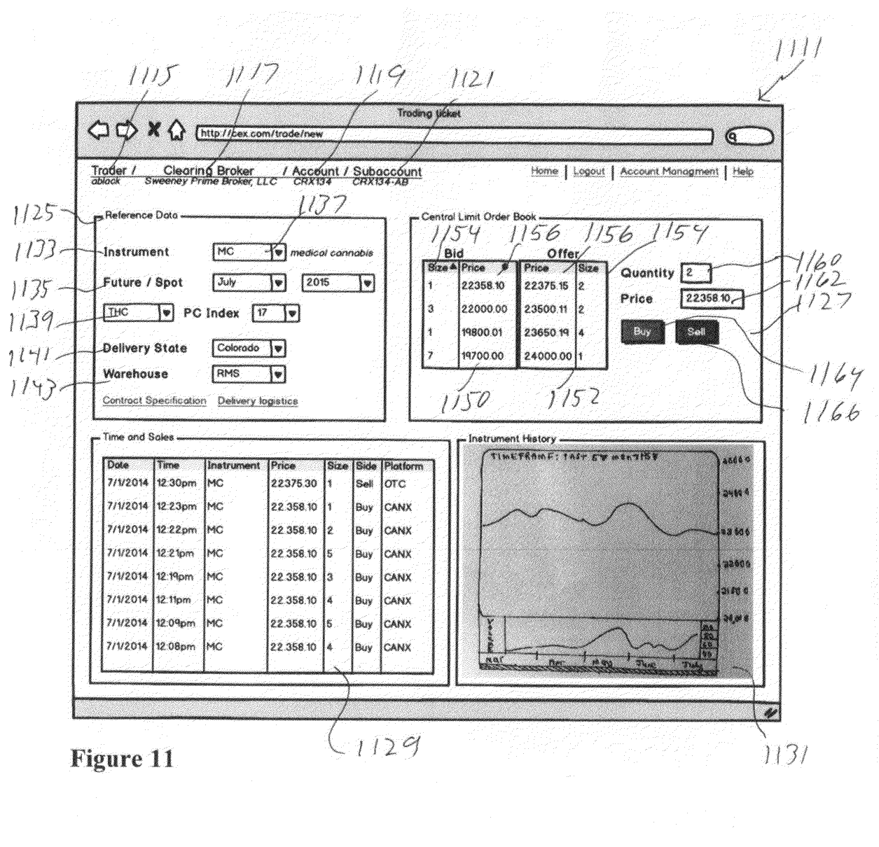

Referring now to FIG. 11, a sample trade ticket screen 1111 of the example electronic trading platform of FIG. 1 is seen. The sample trade ticket screen 1111 comprises a trading ticket user interface enabling a market participant to enter a future or spot transaction via the CLOB. Key information associated with the market participant can be displayed on, for example, the top of the trading ticket user interface 1113, including market participant name 1115, the trader's executing or facilitating broker 1117, and the account 1119 and subaccount 1121 associated with the trade.

The trading ticket user interface 1113 can include, but is not limited to, a reference data section 1125, central limit order book 1127, a time and sales component 1129, and an instrument history graph 1131. The reference data section 1125 is where the market participant can select the instrument 1133 (s)he would like to buy or sell from, for example, a drop-down menu 1137, including the types of financial instrument (future/spot) and date 1135, the appropriate index based on the at least one_chemical compound present within the underlying agricultural product of the present invention 1139, the delivery state 1141, and the delivery location 1143.

The central limit order book 1127 allows the market participant to see the current bids 1150 and offers 1152 posted on the CLOB, and the number of financial instruments 1154 available for a certain price 1156. The market participant may specify the number of financial instruments (s)he is willing to transact 1160, the transaction price 1162, and the side (buy 1164 or sell 1166). A time and sales component 1129 can show the market participant the historical record of trades transacted. Finally, an instrument history graph 1131 can display to the market participant in graphical format the price and volume history of the instrument.

While the invention has been described with specific embodiments, other alternatives, modifications, and variations will be apparent to those skilled in the art. For example, while the commodity described in detail herein is cannabis, a trading platform in accordance with the principles of the present invention could apply to other agricultural commodities having pharmaceutically-relevant compounds. Accordingly, it will be intended to include all such alternatives, modifications and variations set forth within the spirit and scope of the appended claims.

What is claimed is:

1. An electronic financial market for agricultural financial instruments based on an agricultural product comprising embedding an index into a specification for an agricultural financial product, the index based on a chemical compound present within the agricultural product.

2. The electronic financial market for agricultural financial instruments of claim 1 further wherein the agricultural product comprises cannabis.

3. The electronic financial market for agricultural financial instruments of claim 1 further wherein the agricultural financial instrument is sized in a standard measurement that reflects an industry to which the agricultural financial instrument relates.

4. The electronic financial market for agricultural financial instruments of claim 1 further wherein the index based on the chemical compounds present within the agricultural product comprises an index based on the pharmaceutical content present within the agricultural product.

5. The electronic financial market for agricultural financial instruments of claim 4 further wherein the index based on the pharmaceutical content present within the agricultural product comprises a THC pharmaceutical content index.

6. The electronic financial market for agricultural financial instruments of claim 4 further wherein the index based on the pharmaceutical content present within the agricultural product evaluates THC, CBD, and CBN content.

7. A general-purpose digital computer programmed to carry out a series of steps, the series of steps to electronically trade agricultural financial instruments based on agricultural products comprising:
receiving in memory information regarding the agricultural product, including information regarding at least one chemical compound present within the agricultural product;
determining on a processor in communication with the memory an index based on the at least one chemical compound present within the agricultural product;
determining on a processor in communication with the memory a specification for an agricultural financial instrument based on the agricultural product, the specifications incorporating the index;
making available on a display in communication with a memory and a processor the specification, including the index; and
matching on at least one processor the agricultural financial instruments.

8. The general-purpose digital computer programmed to carry out a series of steps, the series of steps to electronically trade agricultural financial instruments based on agricultural products of claim 7 further wherein the agricultural products comprise cannabis.

9. The general-purpose digital computer programmed to carry out a series of steps, the series of steps to electronically trade agricultural financial instruments based on agricultural products of claim 8 further wherein the agricultural financial instruments comprise cannabis futures.

10. The general-purpose digital computer programmed to carry out a series of steps, the series of steps to electronically trade agricultural financial instruments based on agricultural products of claim 8 further wherein the agricultural financial instruments comprise cannabis options.

11. The general-purpose digital computer programmed to carry out a series of steps, the series of steps to electronically trade agricultural financial instruments based on agricultural products of claim 7 further wherein the agricultural financial instruments are sized in standard measurements that reflects an industry to which the agricultural financial instruments relate.

12. The general-purpose digital computer programmed to carry out a series of steps, the series of steps to electronically trade agricultural financial instruments based on agricultural products of claim 11 further wherein a food-grade whole hemp seed future is sized in tons.

13. The general-purpose digital computer programmed to carry out a series of steps, the series of steps to electronically trade agricultural financial instruments based on agricultural products of claim 11 further wherein a food-grade hemp oil future is sized in liters.

14. The general-purpose digital computer programmed to carry out a series of steps, the series of steps to electronically trade agricultural financial instruments based on agricultural products of claim 7 further wherein the index based on the chemical compounds present within the agricultural products comprise a pharmaceutical content index.

15. The general-purpose digital computer programmed to carry out a series of steps, the series of steps to electronically trade agricultural financial instruments based on underlying agricultural products of claim 14 further wherein the pharmaceutical content index comprises a THC pharmaceutical content index.

16. The general-purpose digital computer programmed to carry out a series of steps, the series of steps to electronically trade agricultural financial instruments based on agricultural products of claim 15 further wherein the pharmaceutical content index evaluates THC, CBD, and CBN content.

17. The general-purpose digital computer programmed to carry out a series of steps, the series of steps to electronically trade agricultural financial instruments based on agricultural products of claim 16 further wherein the indexing formula based on the pharmaceutical content index comprises:
$$\frac{( \% THC - \% CBD )}{MAX ( 1 , \% CBN ) .}$$

18. The general-purpose digital computer programmed to carry out a series of steps, the series of steps to electronically trade agricultural financial instruments based on underlying agricultural products of claim 16 further wherein the pharmaceutical content index comprises:
$$\frac{( \% CBD - \% THC )}{MAX ( 1 , \% CBN ) .}$$

19. The general-purpose digital computer programmed to carry out a series of steps, the series of steps to electronically trade agricultural financial instruments based on agricultural products of claim 7 further wherein the agricultural financial instruments comprise food-grade whole hemp seed futures.

20. The general-purpose digital computer programmed to carry out a series of steps, the series of steps to electronically trade agricultural financial instruments based on underlying agricultural products of claim 7 further wherein the agricultural financial instruments comprise industrial hemp whole plant futures.

21. The general-purpose digital computer programmed to carry out a series of steps, the series of steps to electronically trade agricultural financial instruments based on underlying agricultural products of claim 7 further wherein the agricultural financial instruments comprise food-grade hemp oil futures.

22. The general-purpose digital computer programmed to carry out a series of steps, the series of steps to electronically trade agricultural financial instruments based on underlying agricultural products of claim 7 further wherein the agricultural financial instrument comprises a medical cannabis future specification:

23. The general-purpose digital computer programmed to carry out a series of steps, the series of steps to electronically trade agricultural financial instruments based on underlying agricultural products of claim 7 further wherein the agricultural financial instrument comprises a medical cannabis spot specification:

24. The general-purpose digital computer programmed to carry out a series of steps, the series of steps to electronically trade agricultural financial instruments based on underlying agricultural products of claim 7 further including selecting the processor from the group consisting of one processor, more than one processor, and combinations thereof.

25. The general-purpose digital computer programmed to carry out a series of steps, the series of steps to electronically trade agricultural financial instruments based on underlying agricultural products of claim 7 further including selecting the memory from the group consisting of one memory, more than one memory, and combinations thereof.

26. The general-purpose digital computer programmed to carry out a series of steps, the series of steps to electronically trade agricultural financial instruments based on underlying agricultural products of claim 7 further including selecting the display from the group consisting of one display, more than one display, and combinations thereof.

27. A general-purpose digital computer programmed to carry out a series of steps, the series of steps to electronically track transactions involving agricultural products comprising:
receiving in memory information regarding a transaction involving the agricultural products, including delivery, content, and settlement;
receiving in memory information regarding the agricultural products, including information regarding at least one chemical compound present within the agricultural products;
determining on a processor in communication with the memory an index based on the at least one chemical compound present within the agricultural product; and
making available on a display in communication with memory and a processor information about the transactions involving the agricultural products, including the index.

28. The general-purpose digital computer programmed to carry out a series of steps, the series of steps to electronically track transactions involving agricultural products of claim 27 further wherein the agricultural products comprise cannabis products.

29. The general-purpose digital computer programmed to carry out a series of steps, the series of steps to electronically track transactions involving agricultural products of claim 28 further wherein the cannabis products comprise food-grade whole hemp seeds.

30. The general-purpose digital computer programmed to carry out a series of steps, the series of steps to electronically track transactions involving agricultural products of claim 28 further wherein the agricultural products comprises industrial hemp whole plant.

31. The general-purpose digital computer programmed to carry out a series of steps, the series of steps to electronically track transactions involving agricultural products of claim 28 further wherein the cannabis products comprise food-grade hemp oil.

32. The general-purpose digital computer programmed to carry out a series of steps, the series of steps to electronically track transactions involving agricultural products of claim 28 further wherein the cannabis products comprise medical cannabis.

33. The general-purpose digital computer programmed to carry out a series of steps, the series of steps to electronically track transactions involving agricultural products of claim 27 further wherein the index based on the chemical compounds present within the agricultural product comprises a pharmaceutical content index.

34. The general-purpose digital computer programmed to carry out a series of steps, the series of steps to electronically track transactions involving agricultural products of claim 33 further wherein the pharmaceutical content index comprises a THC pharmaceutical content index.

35. The general-purpose digital computer programmed to carry out a series of steps, the series of steps to electronically track transactions involving agricultural products of claim 33 further wherein the pharmaceutical content index evaluates THC, CBD, and CBN content.

36. A general-purpose digital computer programmed to carry out a series of steps, the series of steps to electronically trade an agricultural financial instrument based on an agricultural product comprising:
entering into memory information regarding the agricultural product, including information regarding at least one chemical compound present within the agricultural product;
receiving on a display in communication with a memory and a processor a specification agricultural financial instrument, the specification including an index determined based on the at least one_chemical compound present within the agricultural product;
sending by at least one processor_an order to buy or sell the agricultural financial instrument.

37. The general-purpose digital computer programmed to carry out a series of steps, the series of steps to electronically trade agricultural financial instruments based on agricultural products of claim 36 further wherein the agricultural products comprise cannabis.

38. The general-purpose digital computer programmed to carry out a series of steps, the series of steps to electronically trade agricultural financial instruments based on agricultural products of claim 36 further wherein the agricultural financial instruments are sized in standard measurements that reflects an industry to which the agricultural financial instruments relate.

39. The general-purpose digital computer programmed to carry out a series of steps, the series of steps to electronically trade agricultural fmancial instruments based on agricultural products of claim 36 further wherein the index based on the chemical compounds present within the agricultural products comprise a pharmaceutical content index.

40. The general-purpose digital computer programmed to carry out a series of steps, the series of steps to electronically trade agricultural financial instruments based on agricultural products of claim 36 further wherein the agricultural financial instruments comprise food-grade whole hemp seed futures.

41. The general-purpose digital computer programmed to carry out a series of steps, the series of steps to electronically trade agricultural financial instruments based on underlying agricultural products of claim 36 further wherein the agricultural financial instruments comprise industrial hemp whole plant futures.

42. The general-purpose digital computer programmed to carry out a series of steps, the series of steps to electronically trade agricultural financial instruments based on underlying agricultural products of claim 36 further wherein the agricultural financial instruments comprise food-grade hemp oil futures.

43. The general-purpose digital computer programmed to carry out a series of steps, the series of steps to electronically trade agricultural financial instruments based on underlying agricultural products of claim 36 further wherein the agricultural financial instrument comprises a medical cannabis future specification:

44. The general-purpose digital computer programmed to carry out a series of steps, the series of steps to electronically trade agricultural financial instruments based on underlying agricultural products of claim 36 further wherein the agricultural financial instrument comprises a medical cannabis spot specification:

45. The general-purpose digital computer programmed to carry out a series of steps, the series of steps to electronically trade agricultural financial instruments based on underlying agricultural products of claim 36 further including selecting the processor from the group consisting of one processor, more than one processor, and combinations thereof.

46. The general-purpose digital computer programmed to carry out a series of steps, the series of steps to electronically trade agricultural financial instruments based on underlying agricultural products of claim 36 further including selecting the memory from the group consisting of one memory, more than one memory, and combinations thereof.

47. The general-purpose digital computer programmed to carry out a series of steps, the series of steps to electronically trade agricultural financial instruments based on underlying agricultural products of claim 36 further including selecting the display from the group consisting of one display, more than one display, and combinations thereof.
